(19) United States
(12) Patent Application Publication
(10) Pub. No.: US 2024/0104491 A1
(43) Pub. Date: Mar. 28, 2024

(54) Auto-Constraint Generation for the Optimization of Planned Pickups and Deliveries

(71) Applicant: Google LLC, Moutain View, CA (US)

(72) Inventor: Herbert Czymontek, Mountain View, CA (US)

(21) Appl. No.: 18/010,696

(22) PCT Filed: Mar. 22, 2022
(86) PCT No.: PCT/US2022/021361

§ 371 Date: Dec. 15, 2022

(51) Int. Cl. G06Q 10/0835

(52) U.S. Cl. CPC G06Q 10/08355

(57) ABSTRACT

The present disclosure provides computer-implemented methods, systems, and devices for generating optimized delivery routes. A computing device receives a list of tasks to be performed. The computing device receives delivery constraint data describing constraints associated with one or more tasks in the list of tasks. The computing device accesses location constraint data describing constraints associated with one or more locations of one or more tasks in the list of tasks. The computing device generates an optimized delivery route based on the delivery constraint data and the location constraint data. The computing device transmits the optimized delivery route to a user computing device.

The present disclosure relates generally to route optimization. More particularly, the present disclosure relates to automatically using constraints to generate optimal routes for pickups and deliveries.

### BACKGROUND

With the rise of Internet-based commerce, delivery of goods has become an increasingly important service in a modern economy. The companies that provide this service often have a large number of packages to deliver and pickup on a given day. As a result, optimization of a delivery route can significantly improve the performance of a delivery company. However, a delivery company does not often have enough information to effectively optimize a delivery route.

### SUMMARY

Aspects and advantages of embodiments of the present disclosure will be set forth in part in the following description, or can be learned from the description, or can be learned through practice of the embodiments.

An example aspect is directed towards a computer-implemented method. The method comprises receiving, by a computing device with one or more processors, a list of tasks to be performed. The method further comprises receiving, by the computing device, delivery constraint data describing constraints associated with one or more tasks in the list of tasks. The method further comprises accessing, by the computing device, location constraint data describing constraints associated with one or more locations of one or more tasks in the list of tasks. The method further comprises generating, by the computing device, an optimized delivery route based on the delivery constraint data and the location constraint data. The method further comprises transmitting, by the computing device, the optimized delivery route to a user computing device.

Another example aspect of the present disclosure is directed to a computing device. The computing device comprises one or more processors; and a computer-readable memory. The computer-readable memory stores instructions that, when executed by the one or more processors cause the device to receive a list of tasks to be performed. The instructions further cause the one or more processors to receive delivery constraint data describing constraints associated with one or more tasks in the list of tasks. The instructions further cause the one or more processors to access location constraint data describing constraints associated with one or more locations of one or more tasks in the list of tasks. The instructions further cause the one or more processors to generate an optimized delivery route based on the delivery constraint data and the location constraint data. The instructions further cause the one or more processors to transmit the optimized delivery route to a user computing device.

Another example aspect of the present disclosure is directed towards a computer-readable medium storing instructions. The instructions, when executed by one or more computing devices, cause the one or more computing devices to cause the device to receive a list of tasks to be performed. The instructions further cause the one or more processors to receive delivery constraint data describing constraints associated with one or more tasks in the list of tasks. The instructions further cause the one or more processors to access location constraint data describing constraints associated with one or more locations of one or more tasks in the list of tasks. The instructions further cause the one or more processors to generate an optimized delivery route based on the delivery constraint data and the location constraint data. The instructions further cause the one or more processors to transmit the optimized delivery route to a user computing device.

Other aspects of the present disclosure are directed to various systems, apparatuses, non-transitory computer-readable media, user interfaces, and electric devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 illustrates an example computing environment including a user computing device in accordance with example embodiments of the present disclosure;

FIG. 2 illustrates an example client-server computing environment in accordance with example embodiments of the present disclosure;

FIG. 3 illustrates an example route optimization system in accordance with example embodiments of the present disclosure;

FIG. 4 depict an example user interface according to example embodiments of the present disclosure;

FIG. 5 illustrates an example flow diagram in accordance with example embodiments of the present disclosure; and

FIG. 6 illustrates an example flow diagram in accordance with example embodiments of the present disclosure.

### DETAILED DESCRIPTION

Reference now will be made in detail to embodiments of the present disclosure, one or more examples of which are illustrated in the drawings. Each example is provided by way of explanation of the present disclosure, not limitation of the present disclosure. In fact, it will be apparent to those skilled in the art that various modifications and variations can be made to the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

Generally, the present disclosure is directed towards a system for optimizing delivery routes for delivery services by automatically determining one or more constraints. To do so, a delivery route optimization system can receive a list of tasks from a delivery company. A task can be associated with a particular location (e.g., the location to which a delivery is to be made) and can represent the dropping off or picking up of a package. The delivery route optimization system can also receive delivery constraint information associated with the list of tasks. Delivery constraint information can include information supplied by a delivery company describing the time and manner of delivery. Such constraints can be absolute constraints. Absolute constraints can be constraints that cannot be changed at any cost (e.g., regulations restricting where a delivery vehicle can travel) Other constraints can be relative constraints. Relative constraints can be constraints that can be flexible but can incur costs to do so (e.g., delivery deadlines can be missed, but there can be an incurred planning cost to doing so, high-priority deliveries can be made before low-priority deliveries when possible).

The delivery route optimization system can access location constraint data associated with one or more of the tasks. Location constraint data can be determined based on map data or navigational data for a location associated with one or more tasks. For example, a particular roadway can be limited to foot traffic during particular times. This can represent a location constraint that can affect a delivery to a location along the roadway or a route that travels through the roadway.

In some examples, location constraint data can include data associated with the recipient of a delivery. In some examples, the delivery route optimization system can determine which constraints are relevant for a particular task. The delivery route optimization system can determine whether a location for a task is associated with a business. If so, the delivery route optimization system can access hours of operation data for the business. The delivery route optimization system can generate an optimized delivery route for the list of tasks. The optimized route can be based, at least in part, on the delivery constraints, the location constraints, and the recipient constraints.

In some examples, constraint data can include data associated with one or more aspects of the delivery vehicle. For example, the delivery route optimization system can access information describing the geographic characteristics of the location associated with one or more tasks. For example, the pathways or roads associated with a particular task can be steep such that approaching a task location from a particular location can affect the fuel efficiency of the delivery vehicle. Additionally, one or more factors can affect the wear and tear on the delivery vehicle such as average travelling speed, estimated number of stops, and so on. These factors can also be used as constraints when identifying an optimal route.

Constraints can include information describing the size and weight of packages and the amount of space available in the delivery vehicle. In some examples, a delivery vehicle can have an optimal load that describes the amount of weight that can be in the vehicle before it begins operating at substandard efficiency. As a result, the delivery route optimization system can select a route that allows the delivery vehicle to operate most efficiently. Similarly, electrical vehicles can have constraints that affect the best route for them to take. For example, frequent starts and stops can use battery power more quickly than would be desirable. Thus, constraints can include the frequency of starts and stops associated with an eclectic vehicle. The delivery route optimization system can select a route that allows maximization of the battery life of an electric vehicle.

For example, the delivery route optimization system can receive a list of 20 tasks, including package pick-ups, package deliveries, maintenance stops, refueling stops, driver breaks, and so on. The delivery route optimization system receives data describing one or more delivery constraints, each delivery constraint associated with one or more tasks. The delivery route optimization system can access environmental data based on stored map data about the geographic areas associated with the list of tasks. The delivery route optimization system can generate a route with the tasks arranged in an order based on the route. The route can be optimized based on the delivery constraints and the location constraints. The optimized route can be provided to a delivery company or a specific delivery vehicle. The optimized route can include specific navigational instructions that the driver of a delivery vehicle can follow to complete the list of tasks within the relevant constraints.

More specifically, delivery companies can be tasked with delivering a plurality of packages or other deliveries on a given day. Each specific delivery can have its list of constraints as to when, where, and how, the package is to be delivered. As a result, a significant amount of work is needed to plan the delivery such that all the tasks can be made within the allotted time.

In some examples, rather than a plurality of delivery companies doing the work to generate optimized delivery routes and schedules themselves, a delivery route optimization system can provide optimized routes and schedules via an application programming interface (API). The application program interface can allow delivery companies to provide a list of tasks to the delivery route optimization system. The delivery route optimization system can generate an optimized route and or schedule for these tasks and transmit it to the delivery company as needed.

In some examples, the list of tasks can include tasks that are associated with one or more new delivery routes (e.g., each day can have a new delivery route). Thus, the route can be optimized to begin at the place the delivery vehicle is to begin the day and end where the delivery vehicle is to end the day. In some examples, a delivery vehicle can have a plurality of possible locations at which it may end the day. In other examples, a list of tasks can be an update to a current delivery route (e.g., a route that a delivery vehicle or person is currently progressing along an existing route.)

In some examples, a task represents a particular event that is scheduled to occur at some point during the delivery schedule. In some examples, tasks can include events that are associated with delivery specifically. Tasks associated with delivery can include the picking up and or dropping off a package or other item. Other events can include events that need to be included in the schedule but are not directly related to delivering or picking up packages. Examples of events not directly associated with deliveries or pickups can include filling up a truck with gas, stopping to recharge batteries, taking mandated breaks, allowing drivers to be switched, or allowing the driver to eat a meal.

In some examples, tasks can be associated with a specific location. For example, if a particular task is associated with a package pick up or drop off it will have an associated location. The location can be the location where the pick-up or drop-off is to occur. In other examples, a task can be associated with a type of location but not a specific location. If the delivery vehicle needs to fill up with gas or to recharge a battery, the task can be associated with gas stations or recharge stations generally but not necessarily with a particular location. In some examples, tasks can have specific priorities. A particular package can have a high priority due to a customer paying extra for delivery at a specific time. If so, any optimization of the delivery route can ensure that the high-priority task is scheduled such that the package is delivered at the specified time. Thus, if a customer has paid for high-priority service, the associated task may have a higher priority than other tasks. In some examples, certain tasks can have absolute constraints such that they cannot be moved or prioritized in any way. For example, legally mandated breaks may not be flexible.

Once the delivery route optimization system has received a list of tasks via an API, the delivery route optimization system can identify one or more constraints associated with the list of tasks. Constraints can include a priority of different types of constraints. Some constraints are associated with the delivery service itself and can be referred to as delivery constraints. The delivery service can offer premium delivery services such that particular deliveries must be made at specific times or within specific time ranges. Thus, if a user requests a premium delivery service that guarantees delivery before 11 AM the next day, that delivery time is among one of the delivery constraints. In some examples, the delivery constraints can be received from the delivery company through an application programming interface. The delivery constraints can be delivered concurrently with the list of tasks.

In some examples, constraints can also include location constraints. Location constraints can include constraints associated with the environment around the location at which a delivery is to be made. For example, the delivery route optimization system can have access to a database of map and/or navigational data. The map data can store a variety of information describing locations, points of interest, buildings, roads, parks, and other geographic features. The map data can include information correlating locations with specific geographic locations such that a user can input a location and information about that location (e.g., what buildings if any are at that location).

In some examples, the map data include information that is associated with location determining systems such as the global positioning system (GPS) such that the location of a particular task can be determined with respect to the map data. The map data can include directional data that can be used to generate routes between locations represented in the map data. In some examples, the geographic data store can include location characteristic information about a plurality of locations. As noted above, the location characteristic information can include the location of the location, the geographic position of the location, the type of the location, the average amount of people at that location at particular dates and times, the hours of operation of the location, the goods and services available at the location (if any), any applicable legal regulations or requirements, and so on. The map data can include information describing any legal requirements associated with a particular geographic area. For example, the map data can include a list of roads, each road can have data describing which vehicle types are allowed on the road, any time-based restrictions on the user of the road, the speed limit associated with the road, parking accessibility (and any relevant restrictions), and so on.

In some examples, once constraint data has been accessed, the delivery route optimization system can determine, for each task, which constraints are relevant. For example, a particular location may not have any relevant hours or operations. Similarly, a task may not have any relevant delivery constraints.

Once all relevant constraints have been identified, the delivery route optimization system can generate an optimized route for performing the list of tasks. To do so, the delivery route optimization system can generate a plurality of candidate routes. A score can be generated for each route, representing the cost of the route. For example, a cost of a route can be based on the distance traveled, the amount of time, the fuel expenditure, and the number/amount of constraints associated with the route. The delivery route optimization system can select the candidate route with the lowest cost as the optimized route for performing the list of tasks.

If the list of tasks represents an update to a delivery route that is currently being performed, the delivery route optimization system can generate an updated or reoptimized route. In this way, tasks can be added (e.g., new deliveries or pickups) throughout the delivery day. The system can automatically generate a route that can accommodate the new tasks in the most efficient way.

The optimized route can include specific travel directions and schedule times for tasks. These directions can be transmitted to a delivery vehicle. The delivery professional can follow the optimized route to complete each task in the optimized list of tasks while ensuring that no constraints are violated.

The systems and methods of the present disclosure provide a number of technical effects and benefits. As one example, the proposed systems can provide for automatically accessing relevant constraints associated with a list of tasks. Once the list of relevant constraints is accessed, the system can generate an optimized route for the tasks based, at least in part, on the relevant constraints. Automatically accessing constraints (e.g., time and location constraints relevant to tasks) enables the optimization system to provide more efficient routing and reduce the likelihood of failure due to violation of specific constraints. Improving the effectiveness of delivery services can reduce the time and expense associated with inefficient or unoptimized routes. Reducing wasted time and energy results in reduced cost and reduced wear on delivery vehicles. This represents an improvement in the functioning of the device itself.

Technical benefits of the systems and methods can include automatically selecting a delivery path that extends the useful life of delivery vehicles and operating the vehicle at maximum fuel efficiency. For example, the delivery route optimization system can access constraint data that represents the qualities associated with one or more roads (e.g., steepness, speed limit, state of disrepair, and so on). Using this constraint data, the delivery route optimization system can select routes that reduce wear and tear on the delivery vehicles, increase fuel efficiency, and reduce power usage (e.g., for electric vehicles). Increasing fuel efficiency and reducing power usage, can improve the ability of a delivery service to perform tasks and reduce wasted time. This representing an improvement in the functioning of the delivery vehicles and of the delivery system as a whole.

With reference now to the Figures, example embodiments of the present disclosure will be discussed in further detail.

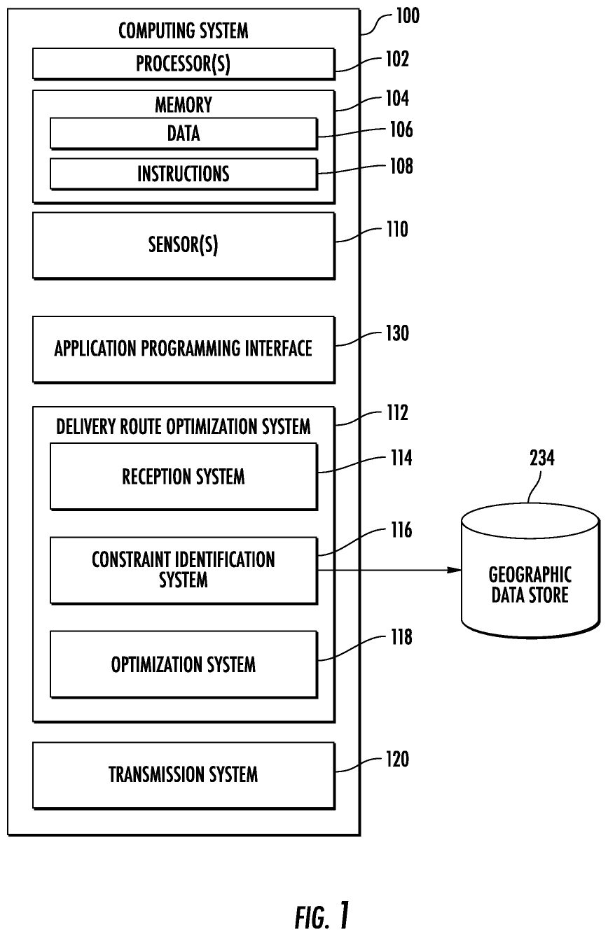

FIG. 1 depicts an example computing system 100 according to example embodiments of the present disclosure. In some example embodiments, the computing system 100 can be any suitable device, including, but not limited to, a smartphone, a tablet, a laptop, a desktop computer, a server computing system, or any other computing device that is configured such that it can allow a person to execute a navigation application or access a navigation service at a server computing system. The computing system 100 can include one or more processor(s) 102, memory 104, an application programmatic interface 130, a delivery route optimization system 112, and a transmission system 120.

The one or more processor(s) 102 can be any suitable processing device, such as a microprocessor, microcontroller, integrated circuit, or other suitable processing device. The memory 104 can include any suitable computing system or media, including, but not limited to, non-transitory computer-readable media, RAM, ROM, hard drives, flash drives, or other memory devices. The memory 104 can store data 106 accessible by the one or more processor(s) 102, including instructions 108 that can be executed by the one or more processor(s) 102. The instructions can be any set of instructions that when executed by the one or more processor(s) 102, cause the one or more processor(s) 102 to provide the desired functionality.

In particular, in some devices, memory 104 can store instructions for implementing the application programmatic interface 130, the delivery route optimization system 112, and the transmission system 120. Thus, the computing system 100 can implement the application programmatic interface 130, the delivery route optimization system 112, and the transmission system 120 to execute aspects of the present disclosure, including receiving a list of tasks from a delivery company, accessing constraint data associated with the list of tasks, and generating an optimized route or routes for performing these tasks.

It will be appreciated that the terms “system” or “engine” can refer to specialized hardware, computer logic that executes on a more general processor, or some combination thereof. Thus, a system or engine can be implemented in hardware, application specific circuits, firmware, and/or software controlling a general-purpose processor. In one embodiment, the systems can be implemented as program code files stored on a storage device, loaded into memory and executed by a processor or can be provided from computer program products, for example computer executable instructions, that are stored in a tangible computer-readable storage medium such as RAM, hard disk, or optical or magnetic media.

Memory 104 can also include data 106, such as map data associated with the delivery route optimization system 112 (e.g., data representing a geographic area including one or more roads and a one or locations of interest received from a server system), that can be retrieved, manipulated, created, or stored by the one or more processor(s) 102. In some example embodiments, such data can be accessed, displayed, or transmitted as needed.

In some example embodiments, the computing system 100 includes an application programmatic interface 130, a delivery route optimization system 112, and a transmission system 120. The application programmatic interface 130 can be a software interface that allows users or computer programs to interact with the service over a network. The API 130 has an associated specification that describes the standard way to interact with the API 130 to achieve a desired result offered by the service for which the API 130 is associated. In this example, the API serves to act as an interface between one or more delivery service companies and the computing system 100.

One or more delivery companies can access and interact with this API 130 to obtain optimized routes for one or more delivery vehicles that are generated by automatically taking a variety of different constraints into account. The different constraints can affect how the route can be optimized. Thus, the delivery company can submit, via the API 130, a list of tasks to be accomplished. The tasks can include delivery events such as delivery and picking up of items. In addition, the tasks can include non-delivery events which can include any event outside of the primary service of the delivery company. For example, a delivery vehicle may need to make stops for maintenance or fueling. These non-delivery tasks can be included in the list of tasks even though they are not directly associated with the delivery of or picking up of packages. These tasks can also be associated with the driver of a delivery vehicle. The driver may have mandatory breaks and or opportunities to have a meal. These non-delivery tasks can be included in the list of tasks that need to be incorporated into an optimized route (or routes) for the delivery company. In this way, the maintenance events and the breaks for the delivery person can be incorporated into the optimized route such that they do not impede the efficient completion of tasks.

In some examples, each respective task can have task data that includes information associated with the task. For example, delivery events and/or pick-up events can have associated locations. The associated location can represent the specific address at which a package is to be delivered or an item is to be picked up. In addition, the task data can include data describing one or more constraints associated with the task. For example, one of the constraints associated with a task can be an associated priority. The priority can represent the importance of the particular task. The priority can act as a constraint such that the delivery route optimizer can select the ordering of tasks such that the higher priority tasks can be accomplished prior to lower priority tasks. As a result of the optimization, it may happen that lower priority tasks will be executed before higher priority tasks if this will not result in a violation of any constraints and an overall lower cost.

In some examples, non-delivery-based tasks can also have associated task data. The associated task data can also include the location. For example, if the driver of a delivery truck has a specific place they would like to stop for lunch, the task representing the lunch stop can have an associated location. In some examples, the location associated with a specific task does not include a particular location but instead includes a location type. For example, if the task is a stop to refuel the vehicle, the location type can be a refueling station. Thus, the delivery route optimization system 112 can select any applicable refueling station. In some examples, the location type can include a preferred refueling station brand or chain of refueling stations (which may have a plurality of qualifying locations) for the delivery company.

In some examples, the task data can include time constraints. For example, time constraints can include that a specific pick up or drop off must take place before, at, or after a certain time.

In some examples, the API 130 can be structured such that it can receive delivery constraint information when the list of tasks is received. In some examples, constraints can be submitted separately from the list of tasks to which they relate. In this way, additional constraints can be added as they arise.

The computing system 100 can include a delivery route optimization system 112. The delivery route optimization system 112 can include a reception system 114, a constraint identification system 116, and an optimization system 118. The reception system 114 can interface with the API 1:30 to receive a list of tasks for a particular delivery company. As noted above, the list of tasks can include one or more delivery constraints. Delivery constraints can be the constraints on the route optimization that are necessitated by one or more factors associated with the delivery company. Thus, delivery constraints can include specific levels of service that can be offered to customers of the delivery company. Thus, the delivery company can have multiple different levels of package priority. For example, the highest level of package priority can include a guarantee that the package will be delivered by a certain time. A customer can pay extra to ensure that the delivery time of the package is guaranteed at a particular time.

In some examples, constraints can be divided into two general types. The first type of constraints can be absolute constraints. Absolute constraints can be any constraint that is not flexible and must be strictly adhered to. Absolute constraints can include mandatory breaks, legal restrictions on where and how delivery vehicles can travel, and so on.

Another type of constraint can be relative constraints. A relative constraint can include constraints that are flexible but result in a planning cost to do so. For example, delivery times, mandatory locations for tasks that typically do not have mandatory locations (e.g., a specific location to refuel a delivery vehicle), a particular order of delivery (e.g., when packages are to be delivered in a specific order), can all represent constraints that would preferably be followed but can be shifted if necessary. Any route that violates a relative or flexible constraint, can have an increased delivery cost. In another examples, relative constraints can constrain the performance of a task in relation to another task. For example, a refueling task can be constrained to occur after a certain number of miles have been traveled or a certain amount of time has passed on the route. Relative constraints can also include priority constraints wherein, high priority deliveries or pickups may occur before low priority pickups if possible.

In addition to the delivery constraints that can be received via the API, the delivery route optimization system 112 can access constraints associated with the list of tasks that are not provided by the delivery company. In this way, the delivery route optimization system 112 can automatically incorporate additional information into the computing system 100 that optimizes the route without the delivery company needing to provide the information.

For example, the delivery route optimization system 112 can access location constraint information from a geographic data store 234. The geographic data store 234 can include information describing the features of a geographic area. The features of a geographic area can include one or more travel ways such as roads, streets, pedestrian travel ways, bike paths, public transportation (e.g., trains, subway, and buses), and so on. The information about the travel ways can include additional information such as speed limits, lane directions, points of intersection, schedules, and so on. The information about travel ways can also include any regulatory restrictions on the use of the travel ways, including information about which vehicles are allowed on the travel ways and at which time.

In addition to data describing roads and other travel ways, the geographic data store 234 can include information about specific locations. For example, the geographic data store 234 can include information associating the coordinates of the global positioning system (GPS) with locations in the map data so that locations can be correlated with locations in the real world. In addition, address data for each location can be included. The map data can include directional data that can be used to generate routes between locations represented in the map data. In some examples, the geographic data store can include location characteristic information about a plurality of locations.

As noted above, the location characteristic information can include the address of the location, the geographic position of the location, the type of the location, the average amount of people at that location at particular dates and times, the hours of operation of the location, the goods and services available at the location (if any), any applicable legal regulations or requirements, and so on. For example, the map data can include other data associated with the locations such as expected density of traffic and parking accessibility (and any relevant restrictions), and so on.

The delivery route optimization system 112 can receive recipient constraint data from one or more recipients. Recipient constraints can include any data describing constraints provided by the recipients themselves. For example, recipients can provide information describing the times at which they are available to receive a package or prepare a package for pickup. In some examples, the recipient constraint better can be included in the delivery data. In other examples, the recipient constraint data can be received by the delivery route optimization system 112 directly from the recipient computing system. Once the reception system 114 has received all relevant constraint data, the constraint identification system 116 can use the received constraint data to determine which constraints are relevant for use in generating an optimal delivery route.

The constraint identification system 116 can determine, for each potential constraint, whether the constraint is relevant to any of the tasks in the list of tasks. For example, if the constraint identification system 116 determines that a bike lane is closed between the hours of 2:00 PM to 8:00 PM, it can determine whether their restriction is relevant or not based on whether or not the delivery vehicle is a bicycle. If not, the constraint can be determined to be irrelevant.

Once the plurality of relevant constraints are determined, the optimization system 118 can generate an optimal route for the one or more vehicles. To do so, the delivery route optimization system can generate a plurality of candidate routes. A score can be generated for each route, representing the cost of the route. For example, a cost of a route can be based on the distance traveled, the amount of time, the fuel expenditure, and the number/amount of constraints associated with the route. The delivery route optimization system can select the candidate route with the lowest cost as the optimized route for performing the list of tasks. In some examples, candidate routes that do not meet the requirements associated with any absolute constraints can be discarded without needing to generate a score.

The optimal route can include a list of instructions for a driver of a delivery vehicle, including one or more navigational directions and instructions at which address to stop to deliver and or pick up packages. In some examples, the optimal route can include the information describing locations for refueling and for driver breaks.

Once the optimal route has been generated, the transmission system 120 can transmit the optimal route and the associated instructions, to the delivery company. In some examples, the optimal route can be transmitted directly to one or more delivery vehicles. In some examples, the delivery vehicles can provide feedback to the computing system 100. The feedback can include data describing any problems that occurred. This information can be used to update the map data in the geographic data store 234 for improvement in future optimizations.

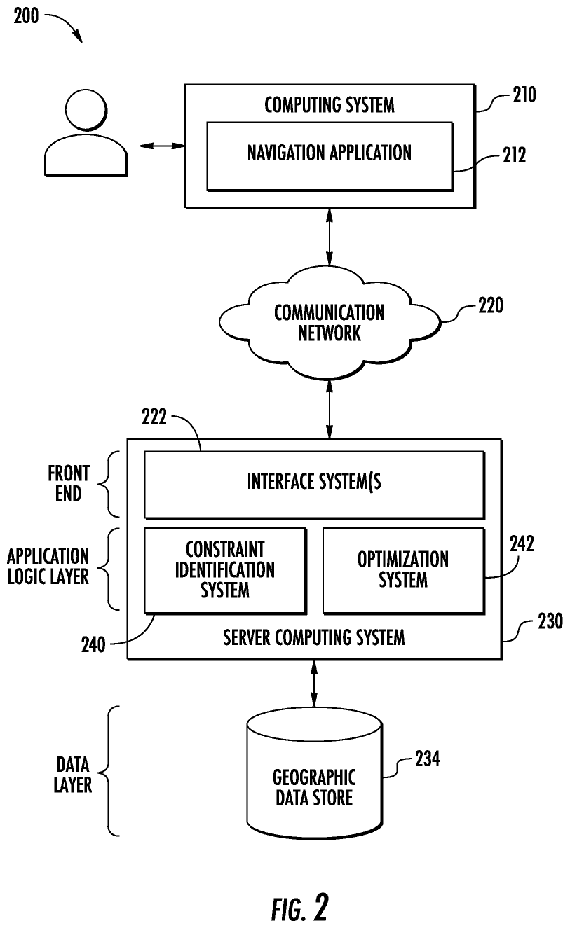

FIG. 2 depicts an example client-server environment 200 according to example embodiments of the present disclosure. The client-server system environment 200 includes one or more computing systems 210 and a server computing system 230. One or more communication networks 220 can interconnect these components. The communication networks 220 may be any of a variety of network types, including local area networks (LANs), wide area networks (WANs), wireless networks, wired networks, the Internet, personal area networks (PANs), or a combination of such networks.

A computing system 210 can include, but is not limited to, personal computers, laptops, computing systems integrated into vehicles, and so on. In some examples, the computing system 210 can be any computing system that can be used by a delivery service (e.g., a third-party system that is involved in the delivery of and picking up of packages) to access the server computing system 230 for the purpose of transmitting a list of tasks to be performed and to receive, from the server system, an optimized route for performing the tasks by one or more delivery vehicles.

In some examples, the computing system 210 can include one or more application(s) 212 such as search applications, communication applications, navigation applications, productivity applications, game applications, word processing applications, or any other applications. The application(s) can include a web browser. The computing system 210 can use a web browser (or other application) to send and receive requests to and from the server computing system 230. The application(s) can include a navigation application that enables the user to implement routes generated by the server computing system 230 and receive navigation information.

In some examples, the computing system 210 can be associated with a delivery company. The delivery company can provide a list of tasks to the server computing system 230 that represents a plurality of deliveries, pickups, and non-delivery related tasks. The computing system can transmit the list of tasks to the server computing system 230 via the network 220. The computing system 210 can transmit a list of delivery constraints to the server computing system 230.

As shown in FIG. 2, the server computing system 230 can generally be based on a three-tiered architecture, consisting of a front-end layer, application logic layer, and data layer. As is understood by skilled artisans in the relevant computer and Internet-related arts, each component shown in FIG. 2 can represent a set of executable software instructions and the corresponding hardware (e.g., memory and processor) for executing the instructions. To avoid unnecessary detail, various components and engines that are not germane to conveying an understanding of the various examples have been omitted from FIG. 2. However, a skilled artisan will readily recognize that various additional components and engines may be used with a server computing system 230, such as that illustrated in FIG. 2, to facilitate additional functionality that is not specifically described herein. Furthermore, the various components depicted in FIG. 2 may reside on a single server computer or may be distributed across several server computers in various arrangements. Moreover, although the server computing system 230 is depicted in FIG. 2 as having a three-tiered architecture, the various example embodiments are by no means limited to this architecture.

As shown in FIG. 2, the front end can consist of an interface system(s) 222, which receives communications from one or more computer systems 210 and communicates appropriate responses to the computer systems 210. For example, the interface system(s) 222 may receive requests in the form of Hypertext Transfer Protocol (HTTP) requests, or other web-based, application programming interface (API) requests. The computing system 210 may be executing conventional web browser applications or applications that have been developed for a specific platform to include any of a wide variety of computing devices and operating systems.

As shown in FIG. 2, the data layer can include a geographic data store 234. The geographic data store 234 can store a variety of navigation data. For example, the geographic data store 234 can include map data. In some examples, the map data can include information describing locations, points of interest, buildings, roads, parks, and other geographic features. The map data can include information correlating addresses with specific geographic locations such that a user can input an address and information about that address (e.g., what buildings if any are at that location). Similarly, a user can enter the name of a location or point of interest and the system can identify the address associated with that location.

In some examples, the geographic data store 234 can include information that is associated with location determining systems such as the global positioning system (GPS) such that the location of a specific computing device can be determined with respect to the map data. The geographic data store 234 can include direction data that can allow the optimization system 242 to generate optimal routes that cover a plurality of locations in the list of tasks received via the interface system 222. In some examples, the geographic data store 234 can include location characteristic information about a plurality of locations. As noted above, the location characteristic information can include the address of the location, the geographic position of the location, the type of the location, the average amount of people at that location at particular dates and times, the hours of operation of the location, the goods and services available at the location (if any), and so on.

In some examples, the geographic data store 234 can also include image data, the image data associated with one or more geographic areas. The geographic data store 234 can also include satellite image data associated with one or more geographic areas.

The application logic layer can include application data that can provide a broad range of other applications and services that allow users (e.g., delivery companies) to submit a list of tasks and receive access or receive geographic data for navigation or other purposes. The application logic layer can include a constraint identification system 240 and an optimization system 242.

The constraint identification system 240 can, in response to receiving a list of tasks from a delivery system, along with a request to provide an optimized route, access data about one or more constraints associated with the list of tasks. The constraints can be accessed from three primary sources. First, delivery constraints can be received from the delivery system itself. Delivery constraints can include constraints describing when and where packages are to be delivered and or picked up. The specific task can have a location at which a package must be delivered as well as the time frame in which the packages must be delivered. In some examples, a time frame can be considered an absolute time constraint and must be met by the optimized route. For example, if a customer has paid extra to ensure that their package is delivered before 10:30 AM, the optimized route must ensure that the associated package is delivered to the associated location before 10 AM.

A second source of constraint information can be location-based constraints. Location-based constraint data can be accessed by the constraint identification system directly and automatically without the input of the delivery service. As above, this information can be retrieved from a geographic data store 234 that includes information describing the features of a geographic area and any laws or regulations that govern traffic or travel through that area. In addition, the geographic data store can include information that describes, for each location, information about what is located at that location. For example, if a business is located at the location the map data in the geographic data store can include information about the hours in which the business is open, delivery preferences, and an address of the business.

A third set of constraints can include recipient constraints. Recipient constraints can include information provided by the recipients of pickups or drop-offs that describe constraints that they can supply. For example, if a particular recipient is leaving on vacation and does not want a package dropped off while they were on vacation, they can provide information indicating that the package should be delivered either before they leave on vacation or after they leave on vacation. Recipients can also provide information about their schedules including a preferred drop-off time. Recipient constraints can be provided from the recipient to the delivery company (and submitted with the list of tasks) or directly to the server computing system 230.

Once the constraint identification system 240 has accessed a list of possible constraints from the different sources, it can determine, for each constraint, whether it is relevant to the list of tasks. In some examples, a constraint can be determined to be irrelevant if it is associated with a mode of travel not used by this particular delivery vehicle or restricts vehicle types not currently being used. For example, some constraints restrict the use of multiaxial trucks on certain roads but not small delivery vans. Thus, if the delivery company is using relatively small delivery vans, constraints for larger vehicles can be determined to be irrelevant.

The relevant constraints can be transmitted, along with a list of tasks, to the optimization system 242. The optimization system 242 can identify an optimal route for completing the list of tasks. In some examples, the optimization system 242 generates a plurality of candidate routes, each candidate route representing a different order in which the tasks could be fulfilled. Optimization system 242 can then generate a score for each route, the score representing the degree to which the route performs the tasks in accordance with the constraints while minimizing other factors such as time and cost. Some constraints, such as absolute time constraints, are fixed by the optimization system 242 such that all route candidates meet these constraints perfectly. Other constraints, such as relative time constraints, may be met differently by different routes. thus, each route can receive a different score based on the degree to which it meets all constraints and one or more other cost factors such as time or money spent

The optimization system 242 can then determine which route has the lowest cost and generate an optimized route including directions and instructions for a driver that represents the route with the lowest score. This optimized route, along with any relevant directions and instructions, can be transmitted to computer system 210. In some examples, the optimized route can be directed transmitted to one or more delivery vehicles for immediate use.

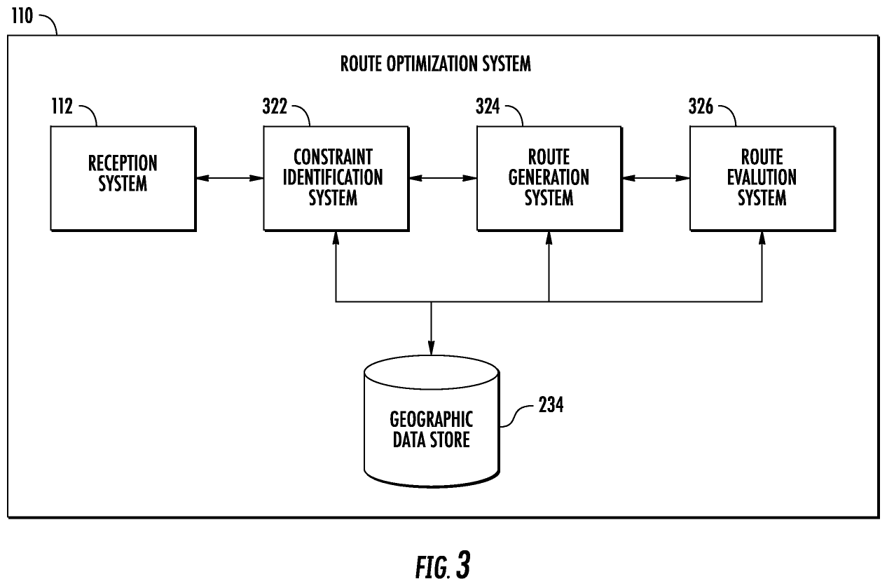

FIG. 3 illustrates an example route optimization system 112 in accordance with example embodiments of the present disclosure. The route optimization system 112 can include a reception system 114, a constraint identification system 322, a route generation system 324, and a route evaluation system 326.

For example, the reception system 114 can receive, through an API, a request to generate an optimal route for a list of tasks. As part of the request to generate an optimized route, the user (e.g., a delivery company) can submit the list of tasks to the route optimization route optimization system 112. The reception system 114 can receive the list of tasks. In some examples, the reception system 114 can also receive a list of constraints associated with the list of tasks. In some examples, the reception system 114 can pass a list of tasks and any associated delivery constraints to the constraint identification system 322.

The constraint identification system 322 can determine, based on the list of tasks, any additional constraints that may be associated with one or more tasks in the list of tasks. For example, each task can have an associated location or a location type. The constraint identification system 322 can access a geographic data store 234 to determine whether any relevant constraints are associated with the locations. For example, some locations are businesses that have hours of operation. The hours of operation can be used to determine one or more time constraints for any deliveries to the business or any pickups from the business.

Other examples of constraints can include travel constraints, in which certain streets or travel ways are designated by law as restricting certain vehicle types. If the particular vehicle type to be used in a given delivery is not allowed on one or more travel ways near a specific task, the constraint identification system 322 can determine that this constraint is relevant when generating an optimal route.

In some example embodiments, the geographic data store 234 can store a variety of navigation data. For example, the geographic data store 234 can include map data. In some examples, the map data can include a series of sub-maps, each sub-map including data for a geographic area including objects (e.g., buildings or other static features), paths of travel (e.g., roads, highways, public transportation lines, walking paths, and so on), and other features of interest. The geographic data store 234 can also include image data, the image data associated with one or more geographic areas. The geographic data store 234 can also include satellite image data associated with one or more geographic areas.

In some examples, the geographic data store 234 can include data describing one or more high traffic zones. The high traffic zones can be constraints for delivering packages in particular geographic locations. For example, if particular times are known to be high-traffic for a particular area, the optimal route may be generated to deliver a package in this area outside of the times associated with high-traffic. High traffic zones can be determined based on data received from user devices with the permission of the users. This data can be analyzed to determine high traffic zones, representing areas with repeating incidents of high traffic (e.g., congestion) or areas of high caution (e.g., school zones when children are leaving or entering). In addition, the geographic data store 234 can include data representing high traffic associated with currently occurring events (e.g., concerts, graduation ceremonies, and so on).

Once one or more relevant constraints are determined for the list of tasks, the constraint identification system 322 can pass the list of tasks and relevant constraints to a route generation system 324. The generation system 324 can generate a plurality of candidate routes for the list of tasks. Any routes that violate an absolute constraint can immediately be discarded. As noted above, an absolute constraint can be a time or travel constraint that is fixed either based on legal restrictions or other inflexible constraints based on services contracted to be performed at a particular time.

As noted above, the list of tasks can represent represents an update to a delivery route that is currently being performed, the route generation system 324 can generate an updated or reoptimized route based on the new tasks in the recently received list of tasks and the route that is currently in progress. Each updated candidate route can represent routes that add extra tasks into the current route in the most optimized way. In some examples, some tasks can be removed from the current route (e.g., shifted to another delivery vehicle or moved to a later occurring route). In this way, tasks can be added (e.g., new deliveries or pickups) throughout the delivery day.

Once all the candidate routes that violate the absolute constraints have been eliminated, the list of candidate routes can be passed to a route evaluation system. The route generation system 324 can generate, for each candidate row remaining, ask or. The score can be representative of the cost of a particular route. Thus, the route score can represent the degree to which the candidate route meets the constraints of the one or more tasks and one or more other metrics including travel time, amount of fuel used, and time spent. One example can include scores that represent the amount of time, fuel, and travel distance used such that a lower score is preferable to a higher score. Such scores can also be affected by the degree to which they match the constraints associated with the list of tasks. For example, flexible constraints may indicate that a given package has a high priority and thus delivering the package earlier in the day is better than later in the day. If this is the case, a score for a candidate route that delivers the high priority package earlier in the day may be better than the score for a candidate route that delivers the high priority package later in the day, all other things being equal. However, the overall score of a route relies on more than just the cost of violating one or more flexible constraints. Thus, a route that violates one or more flexible constraints can still be selected if the overall score is less than other routes which do not violate constraints because the non-constraint related cost factors (e.g., mileage, time, fuel use, and so on) outweigh the cost of constraint violation.

The route evaluation system 326 can then select a candidate route from the candidate routes that have been generated based on the generated scores the candidate routes. This selected route can be transmitted to a delivery service and or one or more delivery vehicles for use in performing the tasks in the list of tasks.

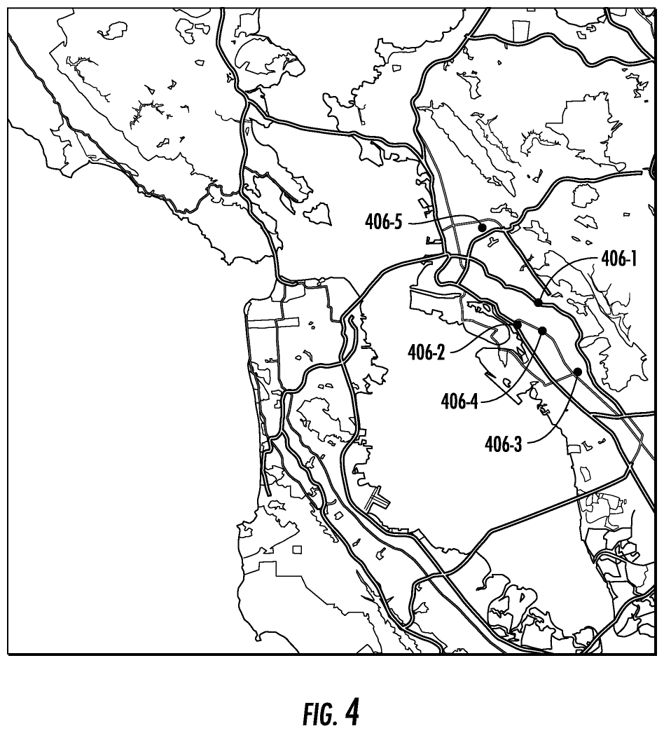

FIG. 4 depicts an example user interface according to example embodiments of the present disclosure. In this example, a user (e.g., a delivery service) has requested an optimal route to perform a series of tasks. A plurality of the tasks can have a specific location associated with them (e.g., 406-1, 406-2, 406-3, 406-4, and 406-5). For example, these tasks can be delivery or pickup tasks. Other tasks in the list of tasks may not have specific locations associated with them but instead may have location types associated with them. For example, if the task is associated with refueling the location type could be a refueling station. Similarly, if the location is associated with a lunch break for the user, the location could be based on the driver's preferences for lunch. The route optimization system can determine an optimal route based on the more constraints associated with the tasks and provide the optimized route for display to a driver of a vehicle in a map display similar to the one displayed. Specific navigation directions can also be provided.

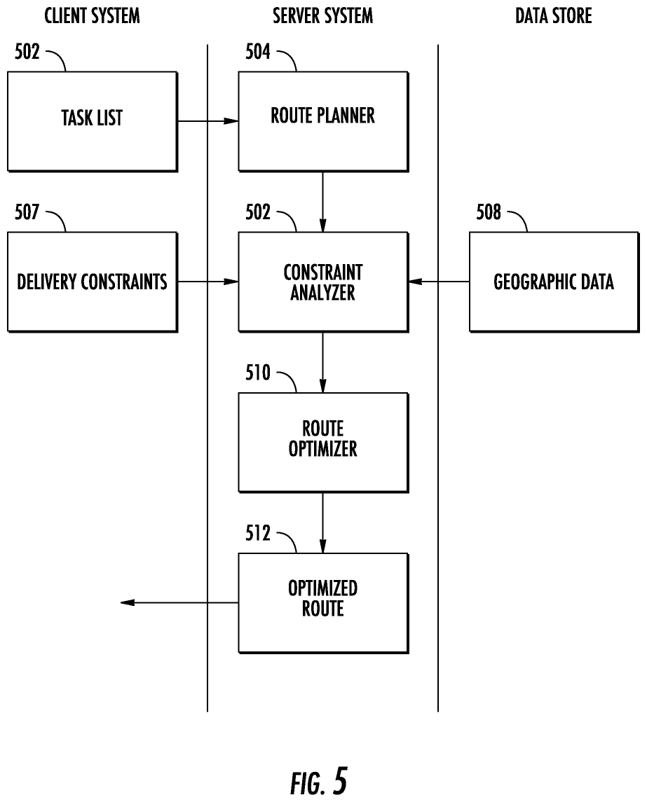

FIG. 5 illustrates an example flow diagram representing the steps for generating an optimal delivery route in accordance with example embodiments of the present disclosure. In this example, a client system can transmit a task list to the server system. While transmitting the task list 502, the client system can also transmit a request for the server system to generate an optimized task route for accomplishing the list of tasks. In some examples, the list of tasks can include delivery and pick-up tasks.

Each delivery and pick-up task can include a specific location as well as an identifier of the specific package or item to be picked up or delivered. Other tasks of the task list cannot be associated with delivery events. For example, those tasks can include tasks representing stops for refueling or recharging and stops for allowing the delivery person to have a break or eat a meal. These non-delivery-based tasks may not have a specific location associated with them. Instead, these non-delivery tasks may have a location type associated with them.

The server system can, at 504, receive the list of tasks. The client can pass a list of tasks 502 to a constraint analyzer 506. The constraint analyzer 506 can access information about potential constraints associated with the list of tasks. For example, the constraint analyzer 506 can receive a list of delivery constraints 507 from the client system. Delivery constraints can include any constraint that is based on the delivery needs of the client system. For example, the delivery service associated with the client system can contract with customers to deliver at certain times or at certain locations. These constraints are integral to any optimized route for performing the task. In some examples, the delivery constraints 507 can include constraints submitted by the recipients of deliveries. For example, the recipients can indicate preferred times for tasks to be completed.

The constraint analyzer 506 can also access information about the geographic area in which the tasks are to be performed. Thus, the constraint analyzer 506 can access geographic data 508 from a geographic data store 234. As noted above, geographic information can include data about which businesses are open at which times and any regulatory or legal constraints on the methods of travel allowed on particular roads and pathways. The constraint analyzer 506 can access geographic areas associated with one or more tasks in the list of tasks. This data can be analyzed to identify one or more constraints in the geographic areas. Each constraint can now be evaluated to determine whether the constraint is relevant to the specific task.

The constraint analyzer 506 can pass the list of tasks and all relevant constraints to the route optimizer 510. The route optimizer 510 can generate a plurality of routes. Any routes that violate one or more absolute constraints can be removed from the list of candidate routes. The route optimizer 510 can generate a score for each candidate group. The score can represent the difficulty or cost of performing the route. For example, a route that takes a long time and includes a lot of miles traveled may receive a higher score than a route that is relatively short and with fewer miles traveled.

The route optimizer 510 can select the can it run with the best score as the optimized route 512. In some examples, the best score represents the lowest score. This optimized route 512 can be transmitted to the client system.

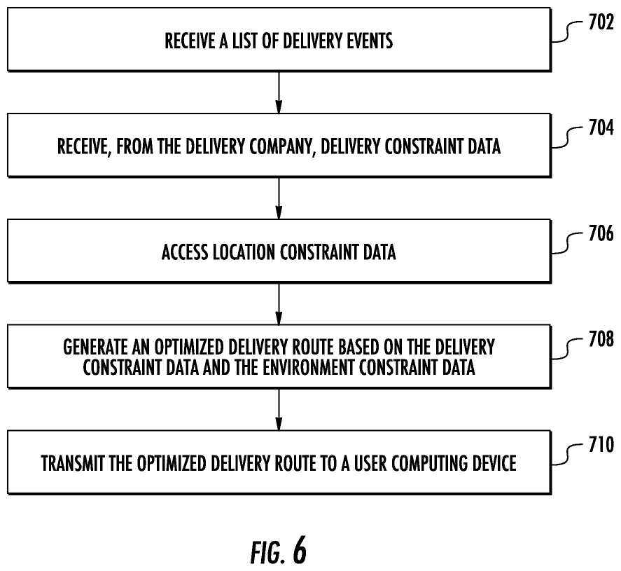

FIG. 6 depicts an example flow diagram for a method of automatically generating optimal routes based on constraint data according to example embodiments of the present disclosure. One or more portion(s) of the method can be implemented by one or more computing devices such as, for example, the computing devices described herein. Moreover, one or more portion(s) of the method can be implemented as an algorithm on the hardware components of the device(s) described herein. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. The method can be implemented by one or more computing devices, such as one or more of the computing devices depicted in FIGS. 1-3.

A computing system (e.g., computing system 100 in FIG. 1) can include one or more processors, memory, and other components that, together, enable the computing system 100 to generate optimal routes for a list of tasks by automatically determining constraints that apply to each task. The computing system 100 can receive a list of tasks from a delivery company or service. The computing system 100 can, at 702, receive delivery constraint data describing constraints associated with one or more tasks in the list of tasks. In some examples, the list of tasks is received from a delivery company via an application programming interface. The computing system 100 can, at 704, receive, from a delivery company, delivery constraint data.

In some examples, the computing system 100 can, at 706, access location constraint data describing constraints associated with the environments of one or more tasks in the list of tasks. In some examples, the computing system 100 can determine, for a respective task and based at least in part on a location associated with the respective tasks, one or more location constraints associated with the location. For example, the location can be an address. In other examples, the location can be set of GPS coordinates.

The computing system 100 can determine, for a respective location constraint from the one or more location constraints associated with task in the list of tasks, whether the respective location constraint is relevant to the one or more tasks in the list of tasks. For example, location constraints can include hours of operation with a merchant location or regulations that constrain which vehicles can travel on particular roads or pathways and at what times. In some examples, the relevance of a location constraint is determined based on one or more of the constraint types, the constraint location, and a time associated with the constraint. For example, if the constraint type is a vehicle type restriction that restricts multi-axle vehicles on a nearby road during particular hours, the constraint may be determined to be non-relevant if the delivery vehicle is not a multi-axle vehicle.

The computing system 100 can receive, from one or more delivery recipients, recipient constraint data; wherein the optimized delivery route is generated, at least in part, based on the recipient constraint data. For example, if the recipient of a package delivery has a preferred time of delivery, this can be included as a recipient constraint.

In some examples, the delivery constraint data includes, for one or more tasks in the list of tasks, data indicating one or more time or location-based constraints associated with the task. A respective task in the list of tasks includes an associated location. For example, a delivery event can include an address at which the delivery is to be made.

In some examples, the location constraint data can include one or more location or time-based constraints determined based on stored map data of the location associated with the respective task. The map data can include one or more transportation restrictions associated with the location of the respective task. The location constraint data can describe one or more time-based travel restrictions. In some examples, the location constraint data can describe one or more legal regulations governing travel or delivery of items at the location associated with the respective task. In some examples, the delivery constraint data or the location constraint data can include one or more absolute constraints. The delivery constraint data or the location constraint data can include one or more relative constraints.

The computing system 100 can generate, at 708, an optimized delivery route based on the delivery constraint data and the location constraint data. The computing system 100 can generate a plurality of candidate routes based on the list of tasks. The computing system 100 can generate a route score for each candidate route based, at least in part, on the delivery constraint data and the location constraint data. The computing system 100 can select an optimized route based on the route scores associated with each candidate route. In some examples, the route score can be based, at least in part, on one or more of cost, distance traveled, and time. The computing system 100 can, at 710, transmit the optimized delivery route to a user computing device.

The technology discussed herein makes reference to sensors, servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method, the method comprising:
receiving, by a computing device with one or more processors, a list of tasks to be performed;
receiving, by the computing device, delivery constraint data describing constraints associated with one or more tasks in the list of tasks;
accessing, by the computing device, location constraint data describing constraints associated with one or more locations of one or more tasks in the list of tasks;
generating, by the computing device, an optimized delivery route based on the delivery constraint data and the location constraint data; and
transmitting, by the computing device, the optimized delivery route to a user computing device.

2. The computer-implemented method of claim 1, further comprising:
receiving, by the computing device and from one or more delivery recipients, recipient constraint data; wherein the optimized delivery route is generated, at least in part, based on the recipient constraint data.

3. The computer-implemented method of claim 1, wherein delivery constraint data includes, for one or more tasks in the list of tasks, data indicating one or more time or location-based constraints associated with the task.

4. The computer-implemented method of claim 1, wherein a respective task in the list of tasks includes an associated location.

5. The computer-implemented method of claim 4, wherein location constraint data includes one or more location or time-based constraints determined based on stored map data of the location associated with the respective task.

6. The computer-implemented method of claim 5, wherein the map data includes one or more transportation restrictions associated with the location of the respective task.

7. The computer-implemented method of claim 5, wherein the location constraint data describes one or more time-based travel restrictions.

8. The computer-implemented method of claim 5, wherein the location constraint data describes one or more legal regulations governing travel or delivery of items at the location associated with the respective task.

9. The computer-implemented method of claim 1, wherein the list of tasks is received from a delivery company via an application programming interface.

10. The computer-implemented method of claim 1, wherein the delivery constraint data or the location constraint data includes one or more absolute constraints.

11. The computer-implemented method of claim 1, wherein the delivery constraint data or the location constraint data includes one or more relative constraints.

12. The computer-implemented method of claim 5, further comprising:
determining, for a respective task and based at least in part on a location associated with the respective tasks, one or more location constraints associated with the location.

13. The computer-implemented method of claim 5, further comprising:
determining, for a respective location constraint from the one or more location constraints associated with an associated location, whether the respective location constraint is relevant to the one or more tasks in the list of tasks.

14. The computer-implemented method of claim 13, wherein the relevance of a location constraint is determined based on one or more of: the constraint type, the constraint location, and a time associated with the constraint.

15. The computer-implemented method of claim 1, wherein generating, by the computing device, an optimized delivery route based on the delivery constraint data and the location constraint data further comprises:
generating, by the computing device, a plurality of candidate routes based on the list of tasks; and
generating, by the computing device, a route score for each candidate route based, at least in part, on the delivery constraint data and the location constraint data.

16. The computer-implemented method of claim 15, further comprising:
selecting, by the computing device, an optimized route based on the route scores associated with each candidate route.

17. The computer-implemented method of claim 15, wherein route score is based, at least in part, on one or more of cost, distance traveled, and time.

18. A computing device, the computing device comprising:
one or more processors; and
a computer-readable memory, wherein the computer-readable memory stores instructions that, when executed by the one or more processors, cause the computing device to perform operations comprising:
receiving a list of tasks to be performed;
receiving delivery constraint data describing constraints associated with one or more tasks in the list of tasks;
accessing location constraint data describing constraints associated with one or more locations of one or more tasks in the list of tasks:
generating an optimized delivery route based on the delivery constraint data and the location constraint data; and
transmitting the optimized delivery route to a user computing device.

19. A non-transitory computer-readable medium storing instructions that, when executed by one or more computing devices, cause the one or more computing devices to perform operations comprising:
receiving a list of tasks to be performed;
receiving delivery constraint data describing constraints associated with one or more tasks in the list of tasks;
accessing location constraint data describing constraints associated with one or more locations of one or more tasks in the list of tasks;
generating an optimized delivery route based on the delivery constraint data and the location constraint data; and
transmitting the optimized delivery route to a user computing device.

20. The non-transitory computer-readable medium of claim 19, the operations further comprising:
receiving, from one or more delivery recipients, recipient constraint data; wherein the optimized delivery route is generated, at least in part, based on the recipient constraint data.
